(19) United States
(12) Patent Application Publication
(10) Pub. No.: US 2019/0036378 A1
(43) Pub. Date: Jan. 31, 2019

(54) POWER SEQUENCER

(71) Applicant: Middle Atlantic Products, Inc., Fairfield, NJ (US)

(72) Inventors: Brendan K. WALSH, Belvidere, NJ (US); Steven KAUFER, Mahwah, NJ (US)

(73) Assignee: Middle Atlantic Products, Inc., Fairfield, NJ (US)

(21) Appl. No.: 15/658,696

(22) Filed: Jul. 25, 2017

(51) Int. Cl. H02J 13/00; H04L 12/26; G05B 15/02; H02J 3/14

(52) U.S. Cl. CPC H02J 13/002; H02J 3/14; G05B 15/02; H04L 43/10

(57) ABSTRACT

A power distribution equipment, and a corresponding method, start a plurality of devices in a predetermined sequence. A first device is started. The equipment repeatedly attempts to communicate with the first device until a response is received, and upon receiving the response from the first device, starts a second device. The sequence is repeated as many times as necessary to start all of the plurality of devices. For some devices, a time delay may be used instead of communication. The devices may be shut down by reversing the same process.

### FIELD OF THE INVENTION

The invention relates to the management of electrical and electronic equipment, especially but not exclusively in the fields of information technology and commercial and other audio/video.

### BACKGROUND

Many electrical and electronic systems involve multiple interconnected devices. When starting up or shutting down such devices, it is often desirable to start them up or shut them down in a specific sequence. Especially when starting up, it is often important to ensure that an earlier device is started and running before a later device is started, because the later device may rely on being able to access the earlier device in order to configure itself at startup.

Existing methods of sequencing rely solely on time based sequencing. Devices are energized in a pre-determined order, with a pre-determined delay between each device and the next. Most of these devices allow only for a single fixed delay time between devices, e.g., each device is energized 1 second after the previous one. Some devices allow for different times between each device, in an effort to minimize sequence time.

With a time based sequence, the installer of the system needs to know how much delay to allow. In some cases this information is provided by the manufacturer of the subject device, but generally it is not. That forces the installer of the system to program each delay for a time that is expected to be long enough, but not too long, or to conduct tests to determine the exact amount of time required for each device to establish a network connection or become fully operational. Where only a single fixed delay time is provided, that delay time must be set for the slowest device in the chain, which will waste time for all the quicker activating devices. Where the delay times are individually programmable, the wasted time can be reduced, but installation and setup then become much more complicated, and any change in the system configuration requires the sequencer to be manually reprogrammed. In addition, if the time taken by a device to start up is variable, the sequence must be predetermined for the maximum time required to start, i.e. worst case scenario, which will waste time on occasions when the device starts up more quickly. The same considerations can apply for a sequence down event.

There is, therefore, a need for an improved method of managing start-up and shutdown sequences.

### SUMMARY

According to an aspect of the present disclosure, there is provided a power distribution equipment, and a corresponding method, that is operative to start a plurality of devices in a predetermined sequence, and that is operative to start a first device, repeatedly attempt to communicate with the first device until a response is received, and upon receiving the response from the first device, to start a second device.

In an embodiment, the second device immediately follows the first device in the predetermined sequence.

In an embodiment, more than one such second device may be started upon receiving the response from a single first device.

In an embodiment, the power distribution equipment is operative to start at least three devices in a predetermined sequence, and is operative, after starting the second device, to repeatedly attempt to communicate with the second device until a response is received, and upon receiving a response from the second device, to start power to the third device. If there are more than three devices, the cycle of starting and communicating may be continued as necessary.

In an embodiment, the power distribution equipment does not attempt to communicate with every device in the sequence. However, where every device is capable of providing a suitable response to a communication, it is often preferred to communicate with every device, to avoid having to configure the starting of any devices individually.

Starting a device may consist simply of the power distribution equipment switching on the power supply to the device, or may involve some other interaction between the power distribution equipment and the device to be started.

Where the power distribution equipment and the first device are connected to a communication network, the attempt to communicate may consist essentially of sending a “ping” message. A ping message is a type commonly available on many networks that merely requests the receiving device to reply, without containing any further payload data. Ping messages are widely used to confirm that another entity exists and is on-line, and to estimate the speed and quality of the communication path. The simplicity and ubiquity of the ping command are well suited to the present purpose, because if a device already supports ping, then no special programming of the device is necessary.

According to another aspect of the present disclosure, there is provided a power distribution equipment that is operative to stop a plurality of devices in a predetermined sequence, and that is operative to command a first device to stop, repeatedly communicate with and receive a response from the first device until a response is no longer received, and upon no longer receiving the response from the first device, to stop a second device or command the second device to stop.

An embodiment uses a command transmitted over a local area network (LAN), such as an SNMP trap, to tell the first device in the chain to begin the shutdown process and establishes a ping connection. Upon failure of the ping connection, indicating the device has shut down, the next device in the chain will be sent an appropriate command transmitted over a LAN (if available) or shut down directly by de-energizing the power source. This process is repeated until all devices are shut down, or until the shutdown sequence is overridden, for example, by the user initiating a sequence up command. The LAN may consist, for example, of an IP network RS485, RS232, or similar. Different controlled devices may be connected over different networks.

Use of ping based sequencing allows distribution of the sequencing equipment over a large area, and devices with dependencies no longer need be connected to the same power source or be in physical proximity. For example, a successful ping response from a Voice Over IP router located in a server room could be used to energize a Power Over Ethernet extender located in a call center in another room or building.

Thus, the power distribution equipment need not be a single device, or in a single location, provided that at every step in the startup or shutdown sequence, the beginning or ending of responses to the communication attempt, or other cue for the next device startup or shutdown, are made available to the appropriate part of the equipment.

The minimum start up time for a system can in many cases be achieved by mixing time based and ping based sequencing, As soon as a device is active on the local network, subsequent devices which are dependent on the previous device will be energized, eliminating the need for time studies to determine appropriate energization delays between devices.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, the drawings show a form of the invention which is presently preferred. However, it should be understood that this invention is not limited to the precise arrangements and instrumentalities shown in the drawings.

FIG. 1 is a schematic diagram of a system of interconnected devices.

FIG. 2 is a flowchart of a startup sequence.

FIG. 3 is a flowchart of a shutdown sequence.

FIG. 4 is a schematic diagram of a system including multiple racklink devices.

### DETAILED DESCRIPTION

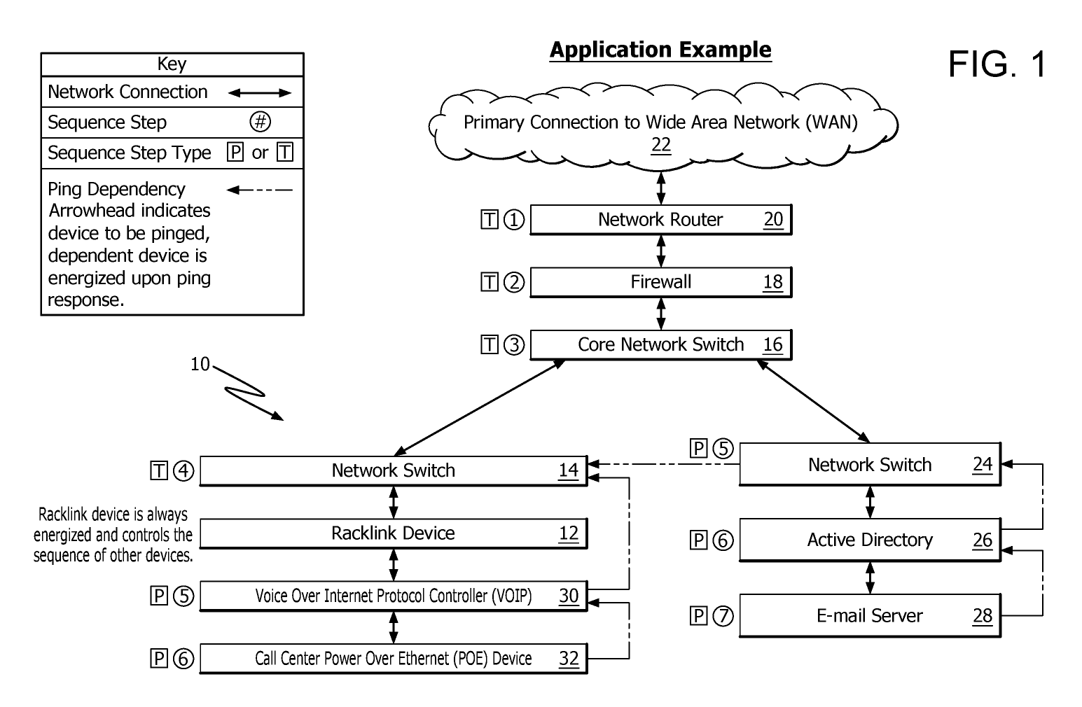

Referring to the drawings, and initially to FIG. 1, a networked system indicated generally by the reference numeral 10 comprises a racklink device 12 that provides the power to, and communicates over a network with, other elements of the system 10. The racklink device 12 is always energized in operation or use of the system 10.

The racklink device 12 communicates with a first network switch 14, which communicates with a core network switch 16. The core network switch 16 is connected through a firewall 18 and a network router 20 to an external wide area network (WAN) 22. The core network switch 16 is also connected through a second network switch 24 to an active directory 26 and an e-mail server 28.

The first network switch 14 is also connected to a Voice-over-Internet Protocol (VoIP) controller 30 and a Power over Ethernet (PoE) device 32 in a call center.

When starting up the system, the active directory 26 and the VoIP controller 30 should not be started until all three network switches 14, 16, and 24 and the firewall 18 and network router 20 are operational, because the active directory 26 and the VoIP controller 30 need to be able to see that much of the overall network in order to configure themselves correctly at startup.

The e-mail server 28 should not be started until the active directory 26, on which it relies, is available.

The call center PoE device should not be started until the VoIP controller 30, through which it receives calls, is operational.

The dependencies are shown by one-headed arrows in FIG. 1, pointing from the later to the earlier device.

In an embodiment, the network router 20 is started first, then the firewall 18, then the core network switch 16, then the first network switch 14. Those devices are started on a timed sequence, because the time that they take to start up is short and predictable, and because it is not critical that each be started before the next, because if the network switches do not see the WAN 22 when they start up, they continually refresh their connection tables while they are active, so can soon bring themselves up to date.

While the first network switch 14 is starting up, it is pinged by the racklink device 12. Only when the first network switch 14 responds to a ping, showing that it is up and active on the network, does the racklink device 12 power up the VoIP controller 30. A ping message is a type commonly available on many networks that merely requests the receiving device to reply, without containing any further payload data. Ping messages are widely used to confirm that another entity exists and is on-line, and to estimate the speed and quality of the communication path.

While the VoIP controller 30 is starting up, it is pinged by the racklink device 12. Only when the VoIP controller 30 responds to a ping, showing that it is up and active on the network, does the racklink device 12 power up the call center PoE device 32.

Only when the first network switch 14 responds to a ping, showing that it is up and active on the network, does the racklink device 12 power up the second network switch 24. The second network device could be powered up sooner, but the network connection between the racklink device 12 and the second network switch 24 is through the first network switch 14 and the core network switch 16, so the next step cannot begin until all three switches are active.

While the second network switch 24 is starting up, it is pinged by the racklink device 12, over the network via the first network switch 14 and the core network switch 16. Only when the second network switch 24 responds to a ping, showing that it is up and active on the network, does the racklink device 12 power up the active directory 26.

While the active directory 26 is starting up, it is pinged by the racklink device 12, over the network via the first network switch 14, the core network switch 16, and the second network switch 24. Only when the active directory 26 responds to a ping, showing that it is up and active on the network, does the racklink device 12 power up the e-mail server 28.

When the networked system 10 is shutting down, the reverse sequence is followed. The shutdown of the active directory 26 is not started until the e-mail server 28 ceases to respond to pings, and therefore presumably is no longer attempting to use the active directory. The shutdown of the VoIP controller 30 is not started until the call center PoE device 32 ceases to respond to pings, and therefore presumably is no longer attempting to use the VoIP controller. The network switches are not shut down until all devices accessed through them stop responding to pings, and are therefore presumably no longer using the network.

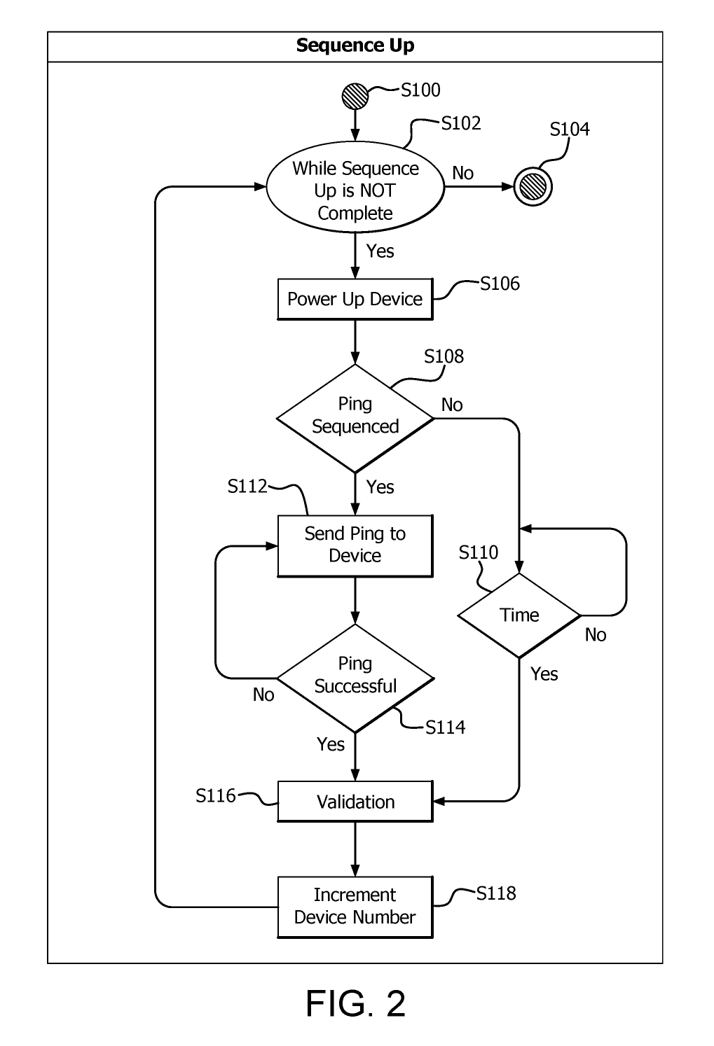

Referring now also to FIG. 2, in one example of a startup sequence, in step S100, the process is initialized for the first device.

In step S102, the process tests whether the sequence has been completed for all devices. If the sequence is complete, then in step S104 the sequence stops. If the sequence is incomplete, then in step S106 the device is powered up.

In step S108, the process decides whether the current device is ping sequenced or time sequenced. If the device is time sequenced, the process waits at step S110 until the time delay has expired, and then proceeds to step S116 or step S118.

If the device is ping sequenced, then in step S112 the racklink device 12 sends a ping message to the device, and in S114 the process tests whether a response is received. If no response is received, the process loops back to step S112 and sends another ping. If no response is received within a time limit, the process may conclude that the device has failed to start properly, and sends out an alarm message (not shown).

Once a ping response is received, the process proceeds to optional step S116, in which other validation tests may be carried out to confirm that the device is operating properly. For example, the racklink device 12 may confirm that the amount of power being drawn by the device is within a normal operating range for that device. If the validation fails, the process may conclude that the device has failed to start properly, and sends out an alarm message (not shown).

After the validation is completed, or if the validation is not carried out, the process proceeds to step S118, increments to the next device in the sequence, and returns to step S102.

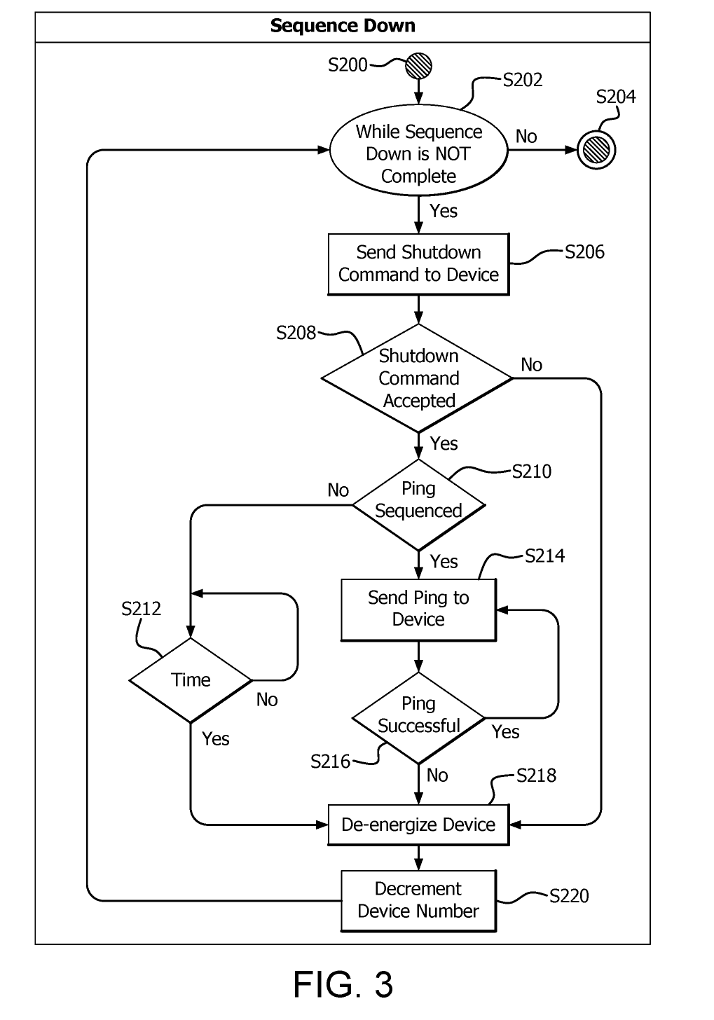

Referring now to FIG. 3, in one example of a process for shutting down a networked system, in step S200, the process is initialized for the first device to be shut down, which is usually the last device in the startup sequence of FIG. 2.

In step S202, the process tests whether the sequence has been completed for all devices. If the sequence is complete, then in step S204 the sequence stops. If the sequence is incomplete, then in step S206, the racklink device 12 sends a command to the device to shut down.

In step S208, the process verifies whether the subject device has acknowledged the command to shut down, and if not, proceeds immediately to step S218 and forces a shutdown by shutting off power to the subject device.

In step S210, the process decides whether the current device is ping sequenced or time sequenced. If the device is time sequenced, the process waits at step S212 until the time delay has expired, and then proceeds to step S218.

If the device is ping sequenced, then in step S214 the racklink device 12 sends a ping message to the device, and in 5216 the process tests whether a response is received. If a response is received, the process loops back to step S214 and sends another ping. If responses are still received after a time limit, the process may conclude that the device has failed to shut down properly, and jump to step S218.

Once ping responses are no longer received, the process proceeds to step S218, increments to the next device in the sequence (which has a lower device number, because the list of devices assumed in FIG. 2 is being used in reverse order), and returns to step S202.

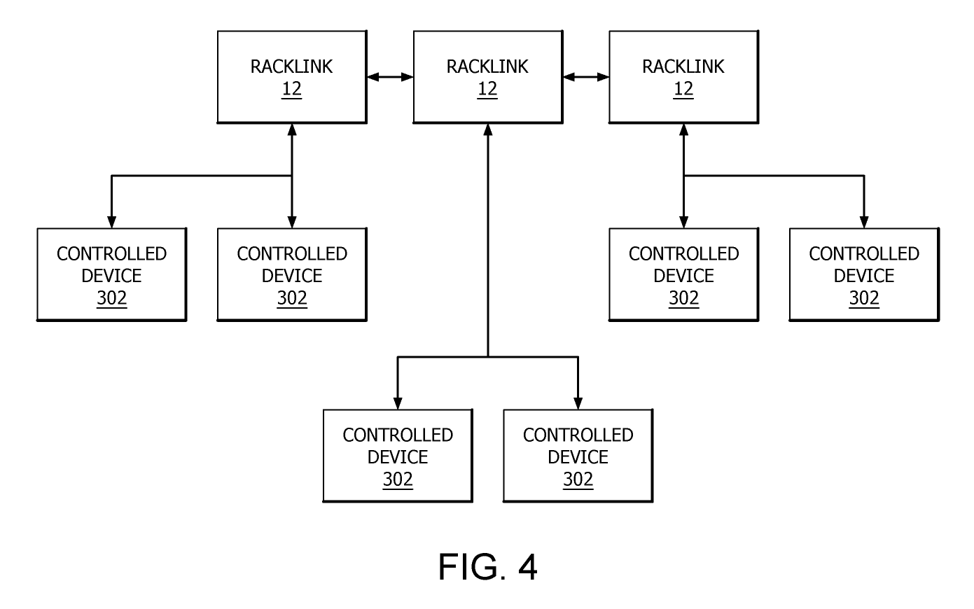

Referring now also to FIG. 4, in an embodiment, two or more racklink devices 12 are connected over a communications network. Each of the racklink devices 12 may be part of, and control, a local system of interconnected devices 302, such as the system shown in FIG. 1.

In the embodiment shown in FIG. 4, the multiple racklink devices 12 may be linked via ping status or through direct communication, such that a successful response or command from one of the racklink devices 12 will instruct an additional racklink device 12 to begin an up or down sequence. Any of the racklink devices 12 may act as a master or slave in this configuration: for example, start up may be initiated by one racklink device 12, with shutdown being initiated by another racklink device 12. Devices 302 attached to different ones of the racklink devices 12 may be sequenced in parallel, where two or more controlled devices 302 energize and de-energize together, or in series where the successful startup or shutdown of a controlled device 302, or of a sequence of controlled devices 302, attached to a first racklink device 12 is used by the first racklink device 12 to trigger an action by another racklink device 12 in the system.

That makes it possible to power up or power down controlled devices 302 in a controlled sequence, even when the controlled devices are spaced apart so that they cannot conveniently be powered from a single racklink device. One example where such sequencing might be useful is an audiovisual system used to relay sound and/or video from an event in one room to a satellite auditorium in a different building.

Any of the racklink devices 12 in the system of FIG. 4 may of course also sequence two or more devices 302 both of which it controls without exchanging a response with or receiving a command from other racklink devices 12, either independently of other racklink devices 12, or as part of a sequence in other parts of which that racklink device directs or is directed by the other racklink devices 12.

It will be seen that one of the racklink devices 12 can also command the other racklink devices 12 to shut down in any order, and with or without pinging each racklink device to confirm that it is shut down before commanding the next racklink device to shut down. Each racklink device 12 can then power itself off in a conventional manner as the last stage of shutting down, or can remain in a “sleeping” state. If some of the racklink devices 12 are in a “sleeping” state in which they are responsive to an external command to restart, another racklink device 12 can also command the sleeping racklink devices 12 to start up in any order, and with or without pinging each racklink device to confirm that it is active before commanding the next racklink device to start up. If the racklink devices are fully powered down, some other action may be necessary by some other entity (including a human operator, not shown) to power them up.

For the purposes of promoting an understanding of the principles of the invention, reference has been made to embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

For example, in FIG. 3, there may be devices that can be simply powered off at their appropriate position in the sequence, jumping directly from step S202 to step S220.

For example, FIG. 1 uses the example of a networked system primarily intended for communication purposes. However, the present methods and apparatus have many other applications, including audio-visual systems where it is desirable to start up and shut down devices in a specific sequence, to avoid spurious signals created by the action of starting up or shutting down one device from propagating undesirably to other parts of the system.

In the interests of simplicity, the examples assume that each device is started up, or shut down immediately after the relevant ping response is received, or is no longer received. If appropriate, however, a time delay may be added.

The following is an example of pseudocode for a process similar to those of FIGS. 2 and 3:

```
    //Pseudocode:
    //Register of Devices, device order is determined by user via UI or
    control protocol:
    Device 0 //first to energize, last to de-energize
    Device 1
    Device 2
    Device 3
    Device 4
    Device 5
    Device 6
    Device....
    Etc...
    //Register of addresses to ping, IP addresses to be pinged during
sequence, addresses are associated with devices above:
    Address 0
    Address 1
    Address 2
    Address 3
    Address 4
    Address 5
    Address 6
    Address....
Etc...
    //Sequence down:
    numDevices = # ; //variable to keep track of number of devices
    deviceNum = numdevices;
    sequenceComplete = FALSE;
    While (sequenceComplete = false)
    {
    sendTrap device(deviceNum);
    Ping device(deviceNum);
    if (pingValid = false && deviceNum > 0)
    {
    Deenergize device(deviceNum);
    deviceNum−−;
    }
    Else
    {
    sequenceComplete = TRUE
    }
    }
    //end While
    //Sequence up:
    numDevices = # ; //variable to keep track of number of devices
    deviceNum = 0;
    sequenceComplete = FALSE;
    While (sequenceComplete = false)
    {
    Energize device(deviceNum);
    Ping device(deviceNum);
    if (pingValid = true && deviceNum < numDevices)
    {
    deviceNum++;
    }
    Else
    {
    sequenceComplete = TRUE
    }
    }
    //end While
```

For the purposes of promoting an understanding of the principles of the invention, reference has been made to embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

1. A power distribution equipment
power outlets;
switches for controlling the supply of power through the power outlets;
a communications unit arranged to communicate information with devices that are supplied with power through the outlets;
wherein the equipment is operative to switch on power to the plurality of outlets in a predetermined sequence, and
is operative to switch on power to a first of the outlets, repeatedly attempt to communicate with a first device that receives power through the first outlet until a response is received, and upon receiving the response from the first device, to switch on power to a second of the outlets.

2. The power distribution equipment of claim 1, wherein the second outlet immediately follows the first outlet in the predetermined sequence.

3. The power distribution equipment of claim 1, which is operative to switch on power to more than one second outlet upon receiving the response from a single first device.

4. The power distribution equipment of claim 1, which is operative to switch on power to at least three said outlets in said predetermined sequence, and is operative, after switching on power to the second outlet, to repeatedly attempt to communicate with a second device that receives power through the second outlet until a response is received, and upon receiving a response from the second device, to switch on power to the third device.

5. The power distribution equipment of claim 1, which is operative to switch on power to at least three said outlets in said predetermined sequence, and is operative, after switching on power to the second outlet, to wait for a predetermined time period and, upon expiry of the predetermined time period, to switch on power to the third device.

6. The power distribution equipment of claim 1, wherein the attempt to communicate comprises sending a ping message over a network.

7. The power distribution equipment of claim 1, comprising at least first and second power switching units, and wherein the first power switching unit is operative to switch on power to said first of the outlets, and upon the equipment receiving the response from the first device, is operative to command the second power switching unit to switch on power to said second of the outlets.

8. A power distribution equipment comprising:
power outlets;
switches for controlling the supply of power through the power outlets;
a communications unit arranged to communicate information with devices that are supplied with power through the outlets;
wherein the equipment is operative to switch off power to the plurality of outlets in a predetermined sequence; and
is operative to command a first device that receives power through a first of the outlets to shut down; repeatedly communicate with the first device until a response is no longer received; and upon no longer receiving the response from the first device, switch off power to the first outlet, and command a second device that receives power through a second of the outlets to shut down.

9. The power distribution equipment of claim 8, wherein the commanding comprises a command sent over a local area network.

10. The power distribution equipment of claim 8, wherein the communicating comprises sending a ping message.

11. The power distribution equipment of claim 8, wherein the second outlet immediately follows the first outlet in the predetermined sequence.

12. The power distribution equipment of claim 8, which is operative to command more than one said second device to shut down upon no longer receiving the response from a single first device.

13. The power distribution equipment of claim 12, which is operative to switch off power to at least three said outlets in said predetermined sequence, and is operative, after commanding the second device to shut down, to repeatedly attempt to communicate with the second device until a response is no longer received, and upon no longer receiving a response from the second device, to command a third device that receives power through a third of the outlets to shut down.

14. The power distribution equipment of claim 13, which is operative to repeat the commanding, communicating, and shutting down for each of a predetermined sequence of power outlets and respective devices.

15. The power distribution equipment of claim 12, which is operative to switch off power to at least three said outlets in said predetermined sequence, and is operative, after commanding the second device to shut down, to wait for a predetermined time period and, upon expiry of the predetermined time period, to switch off power to the second device and command a third device to shut down.

16. The power distribution equipment of claim 8, comprising at least first and second power switching units, and wherein the first power switching unit is operative to switch off power to said first of the outlets, the second power switching unit is operative to switch off power to said second of the outlets, and upon the equipment no longer receiving the response from the first device, the first power switching unit is operative to command the second power switching unit to command the second device to shut down.

17. A method of starting a plurality of devices in a predetermined sequence, comprising:
starting a first device;
repeatedly attempting to communicate with the first device until a response is received; and
upon receiving the response from the first device, starting a second device,

18. The method of claim 17, wherein the second device immediately follows the first device in the predetermined sequence.

19. The method of claim 17, further comprising starting more than one second device upon receiving the response from a single first device.

20. The method of claim 17, further comprising, after starting the second device, repeatedly attempting to communicate with the second device until a response is received, and upon receiving a response from the second device, starting a third device.

21. The method of claim 20, further comprising repeating the starting and communicating until all of a desired sequence of devices have been started.

22. The method of claim 17, wherein the starting a device comprises a power distribution equipment switching on the power supply to the device.

23. The method of claim 17, wherein the attempt to communicate comprises sending a ping message.

24. The method of claim 17, wherein:
wherein the starting the first device comprises a first power switching unit starting the first device;
wherein the repeatedly attempting to communicate with the first device comprises the first power switching unit attempting to communicate;
wherein upon receiving the response from the first device the first power switching unit notifies a power switching unit; and
wherein the starting a second device comprises the second power switching unit starting the second device.

25. A method of stopping a plurality of devices in a predetermined sequence, comprising:
commanding a first device to stop;
repeatedly communicating with and receiving a response from the first device until a response is no longer received; and
upon no longer receiving the response from the first device, shutting off power to the first device and commanding a second device to stop.

26. The method of claim 25, wherein the second device immediately follows the first device in the predetermined sequence.

27. The method of claim 25, further comprising commanding more than one second device to stop upon no longer receiving the response from a single first device.

28. The method of claim 25, further comprising, after commanding the second device to stop, repeatedly communicating with the second device until a response is no longer received, and upon no longer receiving a response from the second device, shutting off power to the second device and commanding a third device to stop.

29. The method of claim 28, further comprising repeating the commanding, communicating, and shutting off until all of a desired sequence of devices have been started.

30. The method of claim 25, /herein the communicating comprises sending a ping message and receiving a ping response.

31. The method of claim 25, wherein the commanding a first device to stop comprises a first power switching unit commanding the first device to stop, wherein upon no longer receiving the response from the first device the first power switching unit notifies a second power switching unit, and wherein the commanding a second device to stop comprises the second power switching unit commanding the second device to stop.
